(19) United States
(12) Patent Application Publication
(10) Pub. No.: US 2008/0008571 A1
(43) Pub. Date: Jan. 10, 2008

(54) Wheel lift lock

(76) Inventor: Michael R. Baughan, Lottsburg, VA (US)

Correspondence Address: LITMAN LAW OFFICES, LTD., P.O. BOX 15035, CRYSTAL CITY STATION, ARLINGTON, VA, 22215, US

(21) Appl. No.: 11/483,090

(22) Filed: Jul. 10, 2006

(51) Int. Cl. B60B 29/00

(52) U.S. Cl. 414/426

(57) ABSTRACT

A wheel lift lock device devoid of the usual straps and ratchet buckles. The device includes a combination of hollow sleeves and hollow tubes. The tubes are adjustably positioned in the sleeves. Locking plungers function to secure the hollow tubes in a desired adjusted position. One of the hollow sleeves is welded to the side of a conventional tow truck lift.

### BACKGROUND OF THE INVENTION

1. Field of the Invention

The present invention generally relates to locking mechanisms. More specifically, the present invention is drawn to a wheel-locking device for towed vehicles.

2. Description of the Related Art

The most commonly utilized system for towing vehicles involves a wheel lift that includes straps and ratchet buckles to secure the vehicle wheel to the wheel lift. This system has serious drawbacks in that it takes from three to five minutes to install on each wheel and the straps become loose during the towing operation, requiring the driver to stop the tow truck and re-tighten the straps. Furthermore, the straps and buckles wear at a prodigious rate and must be replaced. The entire scenario causes loss of time and adds to the towing expense. The art would certainly welcome a wheel lock device or system that could be mounted in a shorter period of time, would secure the wheel tightly without requiring frequent adjustment and would last for longer periods without wearing or maintenance. Thus a wheel lift lock solving the aforementioned problems is desired.

There are many wheel lock devices disclosed in the related art. Pertinent samples of such related art are cited and identified in the accompanying IDS. However, none of the cited and identified related art, taken either singly or in combination, is seen to disclose a wheel lock will subsequently be described and claimed in the instant invention.

### SUMMARY OF THE INVENTION

The present invention is a wheel lift lock device devoid of the usual straps and ratchet buckles. The instant device includes a combination of hollow sleeves and hollow tubes. The tubes are adjustably positioned in the sleeves. Locking plungers function to secure the hollow tubes in a desired adjusted position. One of the hollow sleeves is welded to the side of a conventional tow truck lift.

Accordingly, the invention presents a wheel-locking device that is rugged, efficient and easy to mount. The invention provides for improved elements thereof in an arrangement for the purposes described that are inexpensive, dependable and fully effective in accomplishing their intended purposes.

A clear understanding of the present invention will become readily apparent upon further review of the following specification and drawings.

### BRIEF DESCRIPTION OF THE DRAWINGS

FIG. 1 is an environmental, perspective view of a wheel lift lock according to the present invention.

FIG. 2 is a perspective view of a wheel lift lock according to the present invention.

FIG. 3 is an exploded view of a wheel lift lock according to the present invention.

FIG. 4 is a perspective view of a second embodiment of a wheel lift lock according to the present invention.

Similar reference characters denote corresponding features consistently throughout the attached drawings.

### DETAILED DESCRIPTION OF THE PREFERRED EMBODIMENTS

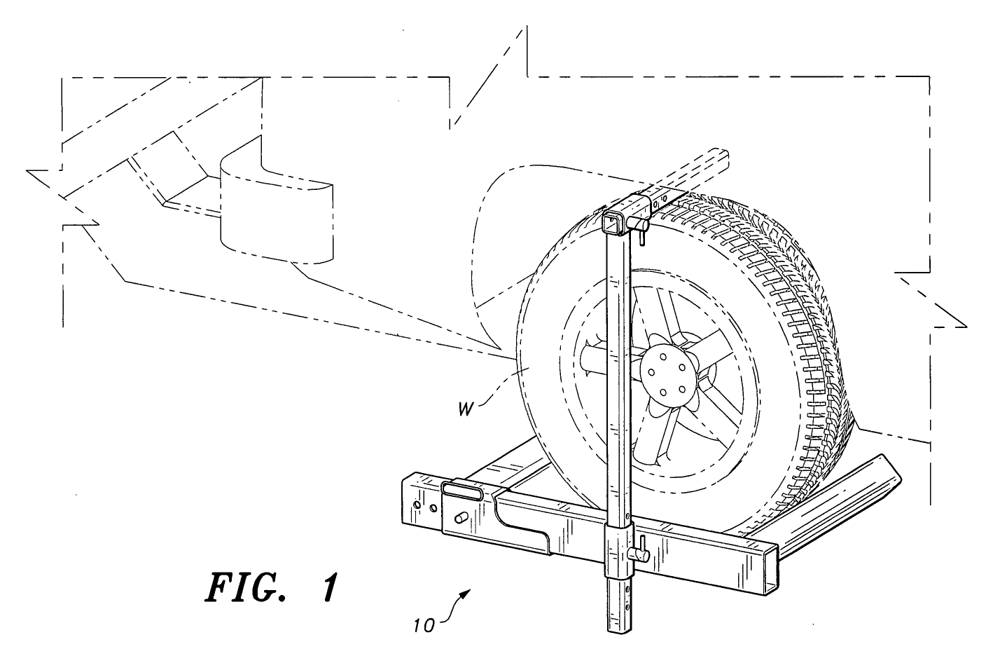

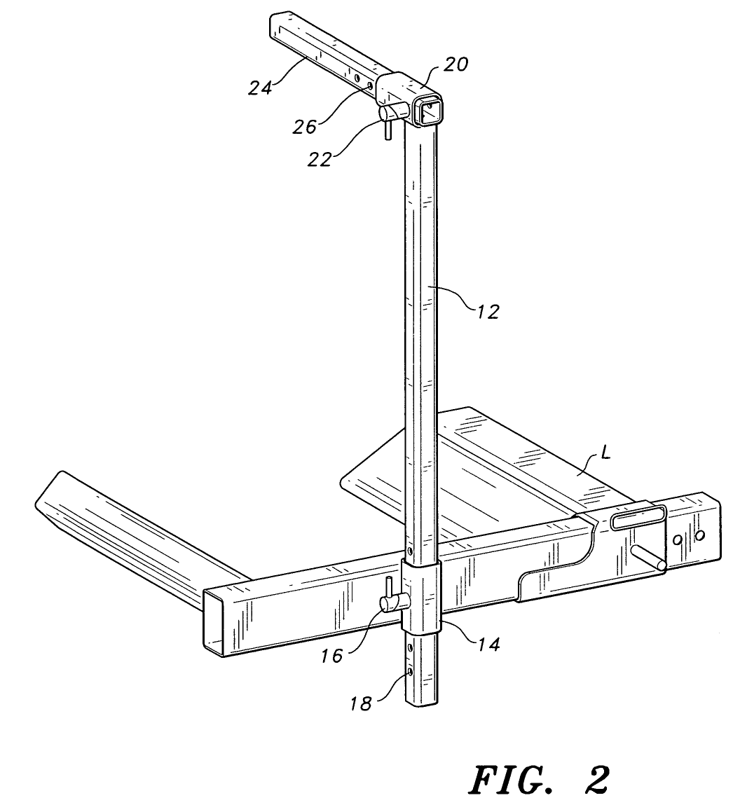

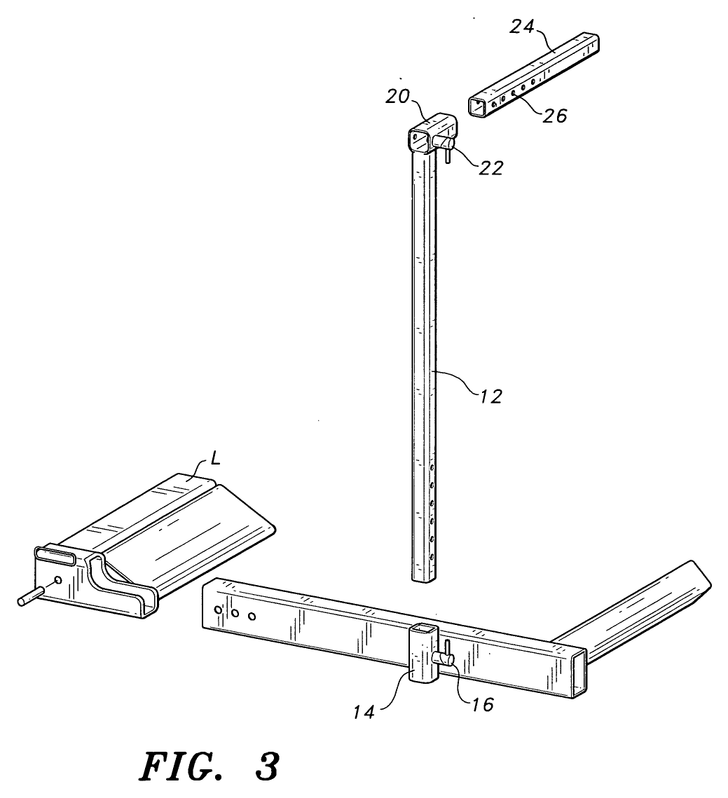

Attention is first directed to FIG. 1, wherein the lift lock of the present invention is generally indicated at 10 and is shown locking wheel W on a lift. As best illustrated in FIGS. 2 and 3, lift lock 10 comprises a first hollow sleeve 14, which sleeve 14 has a vertically-oriented opening. Sleeve 14 is welded to the side of a conventional wheel lift L. Sleeve 14 receives a hollow tube 12 therein. Tube 12 is vertically adjustable in sleeve 14. A lock plunger 16 is mounted on sleeve 14 and functions to engage apertures 18 in tube 12 to secure the tube in a desired vertically-adjusted position. A second hollow sleeve 20, having a horizontally-oriented opening, is affixed to the upper end of tube 12. Sleeve 20 receives a horizontally-oriented tube 24 therein. Lock plunger 22 is operative to engage a respective aperture 26 formed in tube 24 to secure the tube in a desired horizontally-adjusted position. The components of the lift lock, are fabricated from metal; preferably iron.

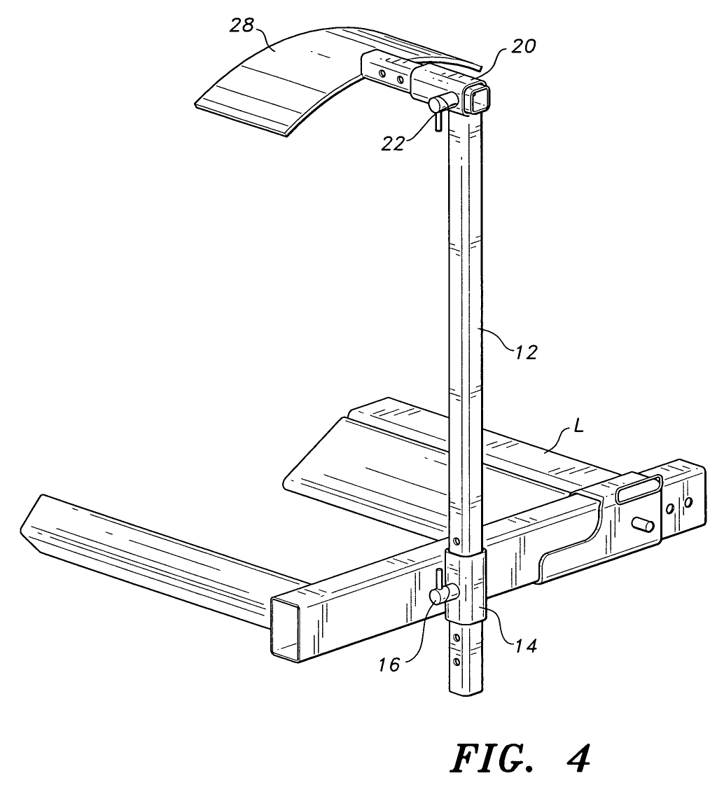

FIG. 4 shows a second embodiment of the invention wherein the tire-engaging end of the tube is replaced with an arched member 28, which arched member conforms to the shape of the wheel W.

In use the lock 10 can be adjusted both vertically and horizontally to conform to the diameter and width of almost any wheel.

It is to be understood that the present invention is not limited to the embodiments described above, but encompasses any and all embodiments within the scope of the following claims.

I claim:

1. A wheel lift lock, comprising:
a first hollow sleeve, said first hollow sleeve attached to a side of a conventional wheel lift;.
a first tube member, said first tube member having an upper end and a lower end, said lower end being adjustably received in said first hollow sleeve;
a second hollow sleeve, said second hollow sleeve affixed to the upper end of said first tube member; and
a second tube member, said second tube member having a first end and a second end, said first end being adjustably received in said second hollow sleeve.

2. The wheel lift lock according to claim 1, further including, a lock plunger disposed on said first hollow sleeve for securing said first tube member in a desired position.

3. The wheel lift lock according to claim 1, further including, a lock plunger disposed on said second hollow sleeve for securing said second tube member in a desired position.

4. The wheel lift lock according to claim 1, wherein said second tube member is perpendicular to said first tube member.

5. A wheel lift lock, comprising:
a first hollow sleeve, said first hollow sleeve having a vertically oriented opening said first hollow sleeve attached to a side of a conventional wheel lift;
a first tube member, said first tube member having an upper end and a lower end, said lower end being adjustably received in said vertically oriented opening of said first hollow sleeve;
a second hollow sleeve, said second hollow sleeve having a horizontally oriented opening, said second hollow sleeve affixed to the upper end of said first tube member; and
a second tube member, said second tube member having a first end and a second end, said first end being adjustably received in said horizontally oriented opening of said second hollow sleeve.

6. The wheel lift lock according to claim 5, including an array of apertures spaced along the lower end of said first tube member.

7. The wheel lift lock according to claim 6, further including, a lock plunger disposed on said first hollow sleeve for engaging one aperture of said array for securing said first tube member in a desired position.

8. The wheel lift lock according to claim 5, including an array of apertures spaced along the first end of said second tube member.

9. The wheel lift lock according to claim 8, further including, a lock plunger disposed on said second hollow sleeve for engaging one aperture of said array for securing said second tube member in a desired position.

10. A wheel lift lock, comprising:
a first hollow sleeve, said first hollow sleeve having a vertically oriented opening said first hollow sleeve attached to a side of a conventional wheel lift;
a first tube member, said first tube member having an upper end and a lower end, said lower end being adjustably received in said vertically oriented opening of said first hollow sleeve;
an array of apertures spaced along the lower end of said first tube member;
a second hollow sleeve, said second hollow sleeve having a horizontally oriented opening, said second hollow sleeve affixed to the upper end of said first tube member;
a second tube member, said second tube member having a first end and a second end, said first end being adjustably received in said horizontally oriented opening of said second hollow sleeve; and
an array of apertures spaced along the first end of said second tube member.

11. The wheel lift lock according to claim 10, further including a respective lock plunger disposed on each of said first hollow sleeve and said second hollow sleeve.

12. The wheel lift lock according to claim 11, further including an arched tire engaging member disposed on the second end of said second tube member.
